(19) United States
(12) Patent Application Publication
(10) Pub. No.: US 2010/0037091 A1
(43) Pub. Date: Feb. 11, 2010

(54) LOGICAL DRIVE BAD BLOCK MANAGEMENT OF REDUNDANT ARRAY OF INDEPENDENT DISKS

(76) Inventors: ANANT BADERDINNI, Duluth, GA (US); Basavaraj Hallyal, Fremont, CA (US); Gerald Smith, Boulder, CO (US)

Correspondence Address: GLOBAL IP SERVICES, PLLC, 10 CRESTWOOD LANE, NASHUA, NH, 03062, US

(21) Appl. No.: 12/186,517

(22) Filed: Aug. 6, 2008

(51) Int. Cl. G06F 11/14

(52) U.S. Cl. 714/6; 714/E11.113

(57) ABSTRACT

Methods and systems for bad data block management of redundant array of independent disks (RAID) are disclosed. In one embodiment, a method for managing a bad data block for a RAID includes filling a first logical block address (LBA) of a first disk having a media error using signature data, filling a second LBA of a second disk offlined from the RAID using the signature data, wherein the second LBA and the first LBA are on a same stripe of the RAID, storing the first LBA and the second LBA to a table in a disk data format (DDF) area associated with the first disk and the second disk, and computing and storing parity values for the stripe of the RAID associated with the first LBA and the second LBA based on data across the stripe.

### FIELD OF TECHNOLOGY

Embodiments of the present invention relate to the field of electronics. More particularly, embodiments of the present invention relate to data management for Redundant Array of Independent Disks (RAID).

### BACKGROUND

RAID, which stands for Redundant Array of Independent Disks, is constructed with one or more physical disks to achieve greater levels of performance, reliability, and/or larger data volume sizes. The RAID, which comes in different configurations (e.g., RAID 0, 1, 2, 3, 4, 5, 6, etc.), copies data across the physical disks and/or performs an error correction using error detecting codes (e.g., parity bits). Accordingly, the data can be protected when a failure in one or more of the physical disks occurs in the RAID. For example, for RAID 5 having disks ‘A’, ‘B’, ‘C’, and ‘D’, a failed disk is replaced by a new one, and the data on the failed disk is rebuilt using the remaining data and the error detecting codes.

However, when a logical block address (LBA) of the disk ‘A’ contains a media error, and if the disk ‘B’ is in an offline state, rebuilding of the LBA in the disk ‘B’, which corresponds to the bad LBA of the disk ‘A’, can be seriously compromised. This is due to the fact that the rebuilding process of the LBA of the disk ‘B’ depends on the error correcting code (e.g., stored in the disk ‘C’) and/or the remaining data across the stripe of the RAID (which is associated with the LBA of the disk ‘A’), such as the bad LBA of the disk ‘A’ and the corresponding LBA of the disk ‘D’. If the rebuilding process of the disk ‘B’ fails as a result of the shortcoming and the disk ‘B’ is put in an offline state, the RAID stays in a degraded state where redundancy of the lost data is not supported. If this problem continues, critical loss of data in the disk ‘B’ may put the whole RAID in an offline state.

One existing solution to correct this problem is to puncture the LBA in the disk ‘B’. However, during the puncturing process, the bad LBA is written with corrupted data such that any further read to the LBA results in an error. Alternatively, a list of addresses of LBAs, such as the LBA of the disk ‘B’, is stored in the RAID's metadata section, and a media error message is issued if a request for one or more LBAs in the list is made. However, the solution may not be able to maintain the redundancy of data stored in the RAID if another disk of the RAID is placed in an offline state. For example, if the disk ‘D’ of the RAID goes in an offline state and has to be rebuilt, the LBA of the disk ‘D’ which corresponds to the bad LBA of the disk ‘A’ may not be recovered since the error correcting code for that particular block may not be available.

### SUMMARY

Methods and systems for bad data block management of redundant array of independent disks (RAID) are disclosed. In one aspect, a method for managing a bad data block for a RAID includes filling a first logical block address (LBA) of a first disk having a media error using signature data, and filling a second LBA of a second disk being rebuilt using the signature data, where the second LBA and the first LBA are on a same stripe of the RAID. The method further includes storing the first LBA and the second LBA to a table in a metadata storage area associated with the first disk and the second disk, and computing and storing parity values for the stripe of the RAID associated with the first LBA and the second LBA based on data across the stripe.

In another aspect, a method for managing a bad data block for a RAID includes accessing data across a stripe and respective parity values of the RAID associated with the stripe when a disk of the RAID is rebuilt, and filling a LBA of the disk using signature data if a respective LBA of another disk of the RAID includes a media error, where the LBA of the disk and the respective LBA are on the stripe of the RAID. The method further includes storing the LBA and the respective LBA to a table in a metadata storage area associated with the RAID, and reconfiguring the parity values for the stripe of the RAID based on a logical operation of the data across the stripe.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Embodiments of the present invention are illustrated by the way of examples and not limited to the figures of the accompanying drawings, in which like references indicate similar elements and in which:

FIG. 1A illustrates a redundant array of independent disks (RAID) with one of its physical disks (PDs) containing a media error at a logical block address (LBA) and another PD in an offline state.

FIG. 1B illustrates an exemplary RAID scheme by virtue of which redundancy of a RAID is maintained during rebuilding operations of multiple PDs, according to one embodiment.

FIG. 2A illustrates the RAID of FIG. 1B with yet another PD in an offline state. FIG. 2B illustrates a rebuilding operation of the offlined PD of FIG. 2A, according to one embodiment.

FIG. 3 is a process flow chart of an exemplary method for managing a bad LBA of a RAID, according to one embodiment.

FIG. 4 is a process flow chart of an exemplary method for managing a bad LBA of a RAID, according to one embodiment.

Other features of the present embodiments will be apparent from the accompanying drawings and from the detailed description that follows.

### DETAILED DESCRIPTION

Methods and systems for logical drive bad data block management of redundant array of independent disks (RAID) are disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

The terms “disk” and “physical disk (PD)” are used interchangeably throughout the document. Further, in the document, a logical block address (LBA) of a disk having a media error (e.g., which is unrecoverable) is referred as a bad LBA.

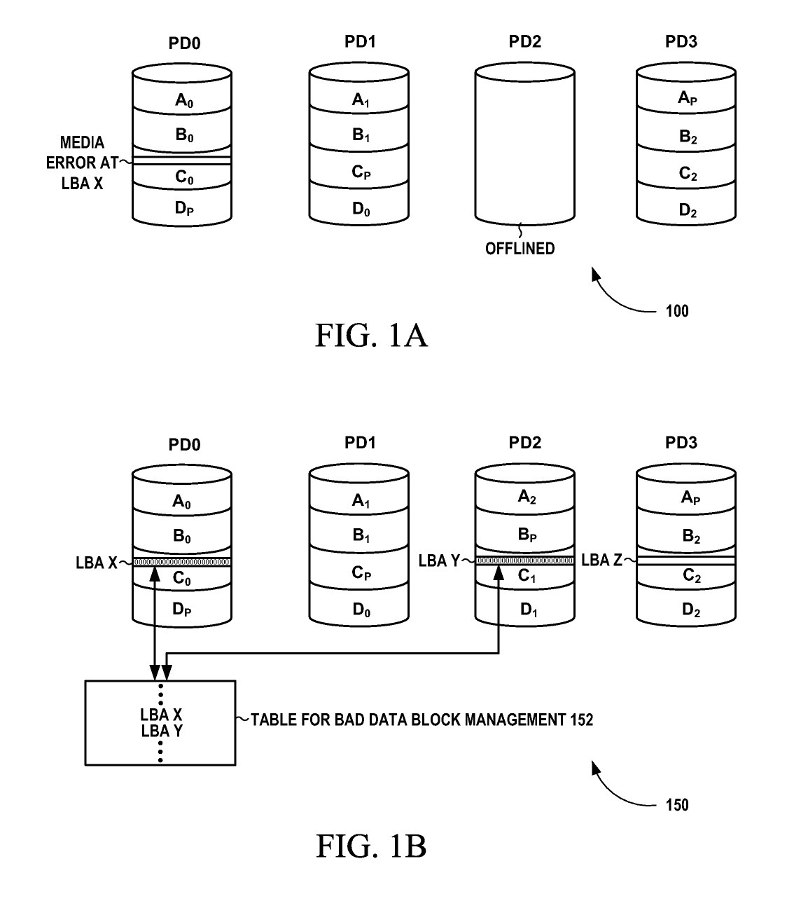

FIG. 1A illustrates a RAID 100 with one of its PDs (e.g., the first disk PD0) containing a media error at an LBA X and another PD (e.g., the second disk PD2) in an offline state. Particularly, FIG. 1A illustrates the RAID 100 including an array of disks PD0, PD1, PD2 and PD3. Each PD includes a number of blocks. It can be seen from FIG. 1A that the disk PD0 includes blocks A₀, B₀, C₀ and D_{P}, the disk PD1 includes blocks A₁, B₁, Cₚ and D₀, and the disk PD3 includes blocks A_{P}, B₂, C₂ and D₂. Also, it can be seen from FIG. 1A that the disk PD2 is offlined with the RAID 100.

Further, as shown in FIG. 1A, the block C₀ in the first disk PD0 includes a media error at the first LBA X. The media error at the first LBA X of the block C₀ may cause loss of redundancy for remaining data blocks in the stripe. In one example embodiment, the rebuilding operation of the second disk PD2 is performed as the second disk PD2 is in the offline state. Further, managing of a bad data block during the rebuilding operation of the second disk PD2 (when the first disk PD0 contains the media error at the first LBA X) for restoring the redundancy of the stripe, using the technique of the present invention is described in description of FIG. 1B that follows.

FIG. 1B illustrates an exemplary RAID scheme by virtue of which redundancy of a RAID 150 is maintained during rebuilding operations of multiple offlined PDs, according to one embodiment. Particularly, FIG. 1B illustrates the RAID scheme for managing a bad data block during the rebuilding operation of the second disk PD2 when the first disk PD0 contains the media error at the first LBA X. It is appreciated that although the RAID scheme for bad data block management is effective with RAID 5 and/or RAID 6 system, it can work with any RAID level. In one embodiment, the first LBA X of the first disk PD0 having the media error is filled with signature data. Then, a second LBA Y of the second disk PD2, being rebuilt, is filled using the signature data.

As shown in FIG. 1B, the signature data filled in the first LBA X and the second LBA Y includes 0's. It is appreciated that only 1's or any combination of 0's and 1's can be used as the signature data. It should be noted that the first LBA X and the second LBA Y are on a same stripe of the RAID 150. Further, the first LBA X and the second LBA Y are stored to a table for bad data block management 152 in a metadata storage area (e.g., disk data format (DDF) area) associated with the first disk PD0 and the second disk PD2. It is appreciated that, elements in the table 152 are sorted such that time taken for locating the elements (e.g., the first LBA X, the second LBA Y, etc.) in the table 152 is minimal. It is also appreciated that, maintaining the table 152 in the DDF area ensures migration of the table 152 from one controller to another, when volumes are migrated. In another embodiment, the table for bad data block management 152 is stored in a memory associated with the RAID 150.

In one example embodiment, parity values (e.g., stored in Cₚ), for the stripe of the RAID 150 associated with the first LBA X and the second LBA Y, are computed and stored based on data across the stripe (e.g., stored in C₀, C₁, and C₂). In one exemplary implementation, an XOR operation of the data across the stripe is performed for computing the parity values for the data across the stripe. For example, the parity value for a third LBA Z of the disk PD3 is computed based on the remaining data across the stripe, i.e., P_{Z}=0̂0̂LBA Z. In this manner, the above-described bad data block management technique provides a parity protection to the LBA Z by computing and storing the parity values of the stripe of the RAID 150.

In one exemplary implementation, the parity values for the stripe of the RAID 150 are computed by applying specific methods to different commands. In one example embodiment, the commands which modify parity values include write, consistency check, RAID level migration, and online capacity expansion commands. In another example embodiment, the commands, that require independent parity generation for the LBA X based on the data across the stripe, include read and rebuild commands.

In accordance with the above-described embodiments, the RAID scheme for managing the bad data block is associated with a read operation, a write operation, a consistency check, a raid level migration and an online capacity expansion, and/or a rebuild operation of the LBA X having the media error. Hence, chances of finding redundancy conditions and restoring redundancy for the entire stripe of the RAID are maximized.

For example, the read operation is a process that is performed when a host issues a read request associated with the bad LBA X. The write operation is a process that is performed when the host issues a write request associated with the bad LBA X. The consistency check is a process where the PDs in the RAID 150 are checked for inconsistencies between data and parity strips, and corrected if found inconsistent. The RAID level migration is a process that involves migration the data layout of the RAID 150 from one level to another. The online capacity expansion is a process of expanding capacity of the RAID 150 by adding additional PDs. The rebuild operation is a process that involves rebuilding of the disk of the RAID 150 which is offlined with the RAID 150.

In one example embodiment, the RAID scheme handles incoming inputs/outputs (I/Os) based on type of I/O. In one embodiment, if a host issues a read operation associated with the first LBA X and the second LBA Y stored to the table 152, then the read operation of the first LBA X and the second LBA Y is returned with a failure message (e.g., indicating the media error). In another embodiment, if the host issues the write operation associated with the first LBA X and the second LBA Y stored to the table 152, then the write operation of the first LBA X deletes the first LBA X from the table 152 and the write operation of the second LBA Y deletes the second LBA Y from the table 152 and the parity values are updated accordingly. It is appreciated that that the RAID scheme described above enables restoring redundancy for the stripe (associated with the first LBA X and the second LBA Y) for the bad LBA with partial parity protection.

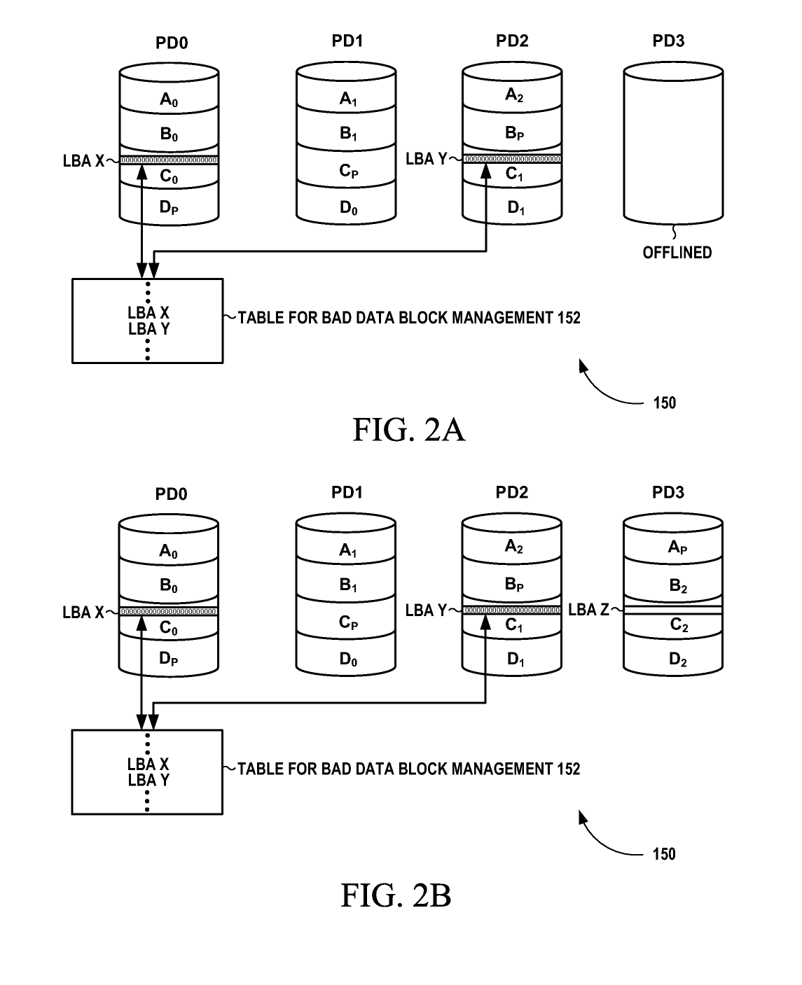

FIG. 2A illustrates the RAID 150 of FIG. 1B with yet another disk PD3 in an offline state. In FIG. 2A, a third disk PD3 is offlined from the RAID 150 subsequent to the rebuilding operation of the second disk PD2 as illustrated in FIG. 1B. In a conventional system, the third disk PD3 cannot be rebuilt since the redundancy of the third LBA Z is lost once the second LBA Y is punctured. However, the RAID scheme illustrated in FIG. 1B makes possible to rebuild the third LBA Z using reconfigured parity values Cₚ based on steps described in FIG. 1B.

FIG. 2B illustrates a rebuilding operation of the offlined disk PD3 of FIG. 2A, according to one embodiment. In FIG. 2B, the third LBA Z is rebuilt using the data (e.g., signature data) of the first LBA X, the second LBA Y, and the parity values Cₚ. When new data is written to the first LBA X or the second LBA Y, the parity values Cₚ are reconfigured based on the new data and the rest of the data across the stripe. It is appreciated that the RAID scheme illustrated in FIG. 1B, FIG. 2A, and/or FIG. 2B can be used for a RAID with more than four physical disks. The RAID scheme may be effective in maintaining redundancy of the RAID when multiple physical disks of the RAID are being rebuilt and/or contain media errors.

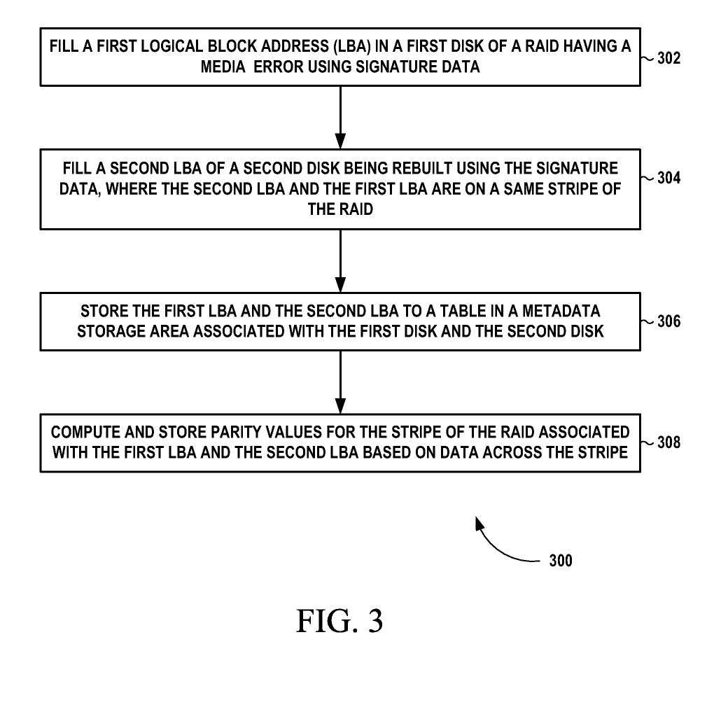

FIG. 3 is a process flow chart 300 of an exemplary method for managing a bad LBA of a RAID, according to one embodiment. In operation 302, a first LBA of a first disk having a media error is filled using signature data. In operation 304, a second LBA of a second disk, being rebuilt, is filled using the signature data. It should be noted that the first LBA and the second LBA are on a same stripe of the RAID.

In operation 306, the first LBA and the second LBA are stored to a table for bad data block management in a metadata storage area associated with the first disk and the second disk. In operation 308, parity values for the stripe of the RAID associated with the first LBA and the second LBA are computed and stored based on data across the stripe. It is appreciated that the parity values for the stripe are computed for a length of a LBA, starting from the media error sector. Moreover, in one example embodiment, a computer readable medium (e.g., firmware for I/O processor and/or controller associated with the RAID 150 of FIG. 1B, FIG. 2A and FIG. 2B) for managing a bad data block for the RAID has instructions that, when executed by a computer, cause the computer to perform the method described for FIG. 3.

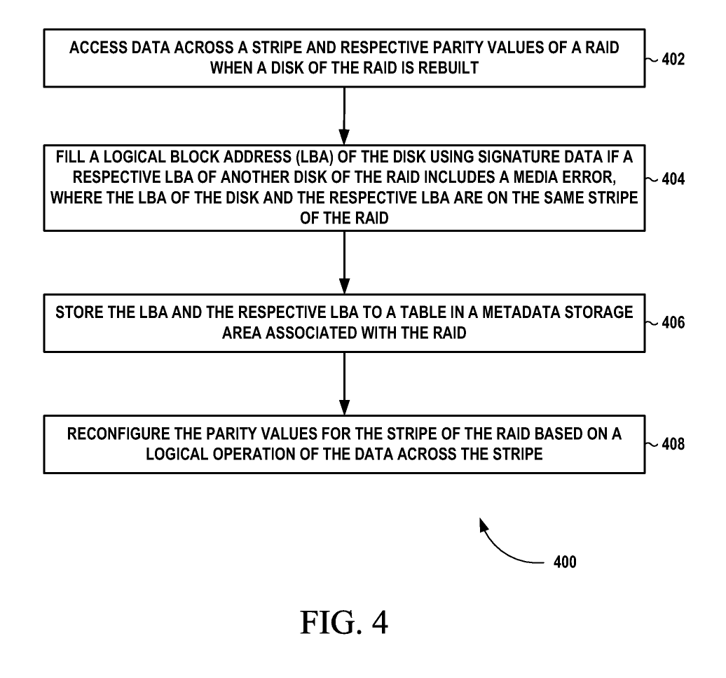

FIG. 4 is a process flow chart 400 of an exemplary method for managing a bad LBA of a RAID, according to one embodiment. In operation 402, data across a stripe and respective parity values of a RAID associated with the stripe are accessed (e.g., read, checked, etc.) when a disk (e.g., a physical disk) of the RAID is rebuilt. In operation 404, a LBA of the disk is filled using signature data if a respective LBA of another disk of the RAID includes a media error. It is appreciated that the LBA of the disk and the respective LBA are on the stripe of the RAID.

In operation 406, the LBA and the respective LBA are stored to a table for bad data block management in a metadata storage area associated with the RAID. In operation 408, the parity values for the stripe of the RAID are reconfigured based on a logical operation on the data across the stripe. Moreover, in one example embodiment, a computer readable medium (e.g., firmware for I/O processor and/or controller associated with the RAID 150 of FIG. 1B, FIG. 2A and FIG. 2B) for managing a bad data block for the RAID has instructions that, when executed by a computer, cause the computer to perform the method described for FIG. 4.

The above-described RAID scheme independently computes parity values for an affected stripe for an LBA width. Further, the above-described method and/or system kicks in for all RAID operations, namely, read operation, write operation, consistency check, RAID level migration. This maximizes the chances of finding redundancy conditions and restoring redundancy for the entire stripe of the RAID. It is appreciated that the above-described system and/or method ensures data availability by providing partial parity restore feature. It should be noted that, in the above-described RAID scheme having a table for bad data block management in I/O path, performance impact on I/Os is very minimal. Further, in this technique, large arrays are significantly benefited as more data blocks are protected.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry).

What is claimed is:

1. A method for managing a bad data block for redundant array of independent disks (RAID), comprising:
filling a first logical block address (LBA) of a first disk having a media error using signature data;
filling a second LBA of a second disk being rebuilt using the signature data, wherein the second LBA and the first LBA are on a same stripe of the RAID;
storing the first LBA and the second LBA to a table in a metadata storage area associated with the first disk and the second disk; and
computing and storing parity values for the stripe of the RAID associated with the first LBA and the second LBA based on data across the stripe.

2. The method of claim 1, wherein the signature data comprises 0's and 1's.

3. The method of claim 1, wherein the computing of the parity values for the stripe comprises performing an exclusive OR (XOR) operation of the data across the stripe.

4. The method of claim 1, wherein the RAID comprises RAID 5.

5. The method of claim 1, wherein the RAID comprises RAID 6.

6. The method of claim 1, wherein the managing the bad data block is associated with a read operation, a write operation, a consistency check, a raid level migration, an online capacity expansion, or a rebuild operation of the RAID.

7. The method of claim 1, wherein a read operation of the first LBA or the second LBA is returned with a failure message.

8. The method of claim 1, wherein a write operation to the first LBA deletes the first LBA from the table and updates the parity values.

9. The method of claim 1, wherein a write operation to the second LBA deletes the second LBA from the table and updates the parity values.

10. The method of claim 1, wherein the metadata storage area comprises a disk data format (DDF) area

11. The method of claim 1, wherein the table is stored in a memory associated with the RAID.

12. The method of claim 1, wherein the storing the first LBA and the second LBA comprises sorting the table to reduce time for locating the first LBA or the second LBA in the table.

13. A method for managing a bad data block for redundant array of independent disks (RAID), comprising:
accessing data across a stripe and respective parity values of the RAID associated with the stripe when a disk of the RAID is rebuilt;
filling a logical block address (LBA) of the disk using signature data if a respective LBA of another disk of the RAID includes a media error, wherein the LBA of the disk and the respective LBA are on the stripe of the RAID;
storing the LBA and the respective LBA to a table in a metadata storage area associated with the RAID; and
reconfiguring the parity values for the stripe of the RAID based on a logical operation of the data across the stripe.

14. The method of claim 13, wherein the signature data comprises 0's and 1's.

15. The method of claim 13, wherein the logical operation comprises an exclusive OR (XOR) operation.

16. The method of claim 13, wherein the RAID comprises RAID 5 and RAID 6.

17. The method of claim 13, wherein a read operation of the LBA or the respective LBA is returned with a failure message.

18. The method of claim 13, wherein a write operation to the LBA deletes the LBA from the table and updates the parity values.

19. The method of claim 13, wherein a write operation to the respective LBA deletes the respective LBA from the table and updates the parity values.

20. A computer readable medium for managing a bad data block for redundant array of independent disks (RAID) having instructions that, when executed by a computer, cause the computer to perform a method comprising:
filling a first logical block address (LBA) of a first disk having a media error using signature data;
filling a second LBA of a second disk being rebuilt using the signature data, wherein the second LBA and the first LBA are on a same stripe of the RAID;
storing the first LBA and the second LBA to a table in a metadata storage area associated with the first disk and the second disk; and
computing and storing parity values for the stripe of the RAID associated with the first LBA and the second LBA based on data across the stripe.
